(19) United States
(12) Patent Application Publication
(10) Pub. No.: US 2008/0102180 A1
(43) Pub. Date: May 1, 2008

(54) Cheese Granules Composition and Cheese Containing Granules Composition

(75) Inventors: Lynn Ragan, Miami, FL (US); Eduardo Godinez, Chesterfield, MO (US); Matthew K. McMindes, Chesterfield, MO (US); Rosa I. Sanchez, St. Louis, MO (US)

Correspondence Address: Solae, LLC, 4300 Duncan Avenue, Legal Department E4, St. Louis, MO, 63110, US

(73) Assignee: Solae, LLC, St. Louis, MO (US)

(21) Appl. No.: 11/923,048

(22) Filed: Oct. 24, 2007

Related U.S. Application Data
(60) Provisional application No. 60/862,663, filed on Oct. 24, 2006.

(51) Int. Cl. A23C 19/093; A23C 21/08

(52) U.S. Cl. 426/538; 426/582; 426/656

(57) ABSTRACT

The present invention is directed to protein granule compositions as well as cheeses compositions containing the protein granule compositions. The protein granule composition is selected from the group consisting of a whey protein granule composition that comprises a vegetable protein material and a liquid dairy whey; wherein the weight ratio of the vegetable protein material to the liquid dairy whey is from about 1 to about 2-6 and a milk protein granule composition that comprises a vegetable protein material and a liquid milk; wherein the weight ratio of the vegetable protein material to the liquid milk is from about 1 to about 2-6.

### CROSS REFERENCE TO RELATED APPLICATIONS

This application claims priority from Provisional Application Ser. No. 60/862,663 filed on Oct. 24, 2006, which is hereby incorporated by reference in its entirety.

### FIELD OF THE INVENTION

This invention relates to a protein granule composition, as well as a cheese composition utilizing the protein granule composition. The invention further relates to a process for the preparation of the protein granule composition, as well as a process for the preparation of the cheese composition utilizing the protein granule composition.

### BACKGROUND OF THE INVENTION

Milk has a whey proteins to casein ratio of about 1:4. However, by the time the whey is drained, the resulting cheese has a whey proteins to casein ratio of less than about 1:40. Some processes have included steps to recover the whey proteins from the whey and combine them with the cheese. Typically, whey proteins recovered from whey are not used to any significant extent in commercial processes for making conventional natural cheese or pasteurized process cheese.

Milk proteins can be divided into two general classes, namely, the serum or whey proteins and the curd or casein products. Casein is generally classified as a phosphoprotein but in reality is a heterogeneous complex of several distinct and identifiable proteins (alpha, beta, kappa, et cetera, proteins), phosphorous and calcium which complex takes the form of a colloidal calcium salt aggregate in milk called calcium caseinate. During the production of cheese, casein is precipitated from the milk by several methods. One method involves the treatment of the milk with acid to lower the pH to about 4.7 whereupon the casein proteins precipitate from the milk to form the curd which will ultimately be processed to cheese. Another method involves the fermentation of the milk with cheese cultures to lower the pH to 4.7 to precipitate the casein proteins from the milk to form the curd. In a third method, the precipitation of the casein is accomplished using a rennet enzyme rather than acid. The casein produced by the first two methods is generally higher in fat and lower in ash than the corresponding product derived from the third method. The difference in the ash content is believed to be a result of calcium phosphate being split off of the casein molecules by the action of the acid, with the residual ash being mostly organically bound phosphorous. The “acid casein” is used in the production of soft cheeses such as cottage cheese, while the “rennet casein” or “para-casein” is utilized in the manufacture of cheeses such as cheddar or mozzarella.

Whey is the serum remaining after the solids (fat and casein) are removed from the milk. Whey comprises lactalbumin and lactoglobulin proteins. Lactalbumin makes up 2% to 5% of the total skim milk protein and is believed to function in milk as a proteinaceous surfactant stabilizer of the fat particles. Lactoglobulin makes up another 7% to 12% of the total skim milk protein and is closely associated with the casein protein in whole milk. Whey derived from the acid precipitation process mentioned above is referred to as acid or sour whey and generally has a pH of about 4.3 to 4.6. Whey derived from the enzymatic precipitation process, also mentioned above, is referred to as sweet whey and generally has a pH of from about 5.9 to about 6.5. As a generalization, commercial dried whey comprises about 10% to 13% protein, 71% lactose, about 2% lactic acid, about 3% to 5% water, about 8% to 11% ash, and includes a low concentration of phosphoric anhydride. As derived from the cheese making process, whey generally is an aqueous medium comprising 90% or more water. The respective characteristics of sweet and acid wheys are summarized in Table 1 below:

TABLE 1

| Component | Sweet | Acid |
|---|---|---|
| Lactose | 4.0-5.0% | 4.0-5.0% |
| Dry Solids | 5.3-6.6% | 5.3-6.0 |
| Proteins | 0.6-0.8% | 0.7-0.7% |
| Minerals & Salts* | 0.4-0.6% | 0.7-0.8% |
| Fats | 0.2-0.4% | 0.05-0.1% |

*Primarily Na⁺, K⁺ and Ca²⁺ salts
It is noted that U.S. Pat. No. 4,358,464 discloses a proposal for converting acid whey to sweet whey.

Although both whey itself and whey components such as the whey proteins lactalbumin and lactoglobulin and the sugar lactose all have various known utilities, there are significant difficulties in converting the whey into industrially useful forms. The fundamental difficulty is that whey as obtained from the cheese making process contains, as mentioned above, about 90% water and none of the components are generally useful in that form. The removal of the excess water is very expensive and is most likely to remain so in view of present and projected energy costs. Moreover, the useful proteins contained in whey make up only a minor proportion, some 9% to 11% by weight, of the whey solids. The major portion of the balance of the whey solids, i.e. greater than 70% by weight thereof, is lactose. The commercial value of lactose was and is, however, quite low. The end result was that whey was generally considered by the cheese maker to have little value and indeed, as merely an item to be disposed of at the least possible cost. Quite often the whey was merely dumped, by draining to sewer. In more recent times, however, increased awareness of the possible pollution of the environment has resulted in the imposition of severe restrictions on such disposal methods to the extent where whey became almost a liability in the context of the cheese making process. Although some local authorities will accept whey and its related products for treatment in their sewage systems, their charge for doing so is very high. One of the alternatives which then became feasible in order to reduce the costs associated with whey disposal, was to heat the by-product so as to heat denature and coagulate the protein, principally lactalbumin, which could then be separated in a coarse, non-functional form from the residual lactose syrup. The resulting products were then sold to defer the processing costs to below the disposal costs. More preferably the whey was then simply dried using spray, drum or freeze drying and the like, to produce a hygroscopic product. Typical of the products produced by such means are dried whey animal feed supplements comprising a minimum of 65% lactose and about 12% protein. These supplements have higher concentrations of riboflavin than does skim milk and the supplements are generally valued in feed mixtures as a source of this and other solubles (see Encyclopedia of Chemical Technology, Vol. 6, page 308).

### SUMMARY OF THE INVENTION

The present invention is directed to protein granule compositions as well as cheeses compositions containing the protein granule compositions.

In one embodiment, the protein granule composition is a whey protein granule composition that comprises

a vegetable protein material and

a liquid dairy whey;

wherein the weight ratio of the vegetable protein material to the liquid dairy whey is from about 1 to about 2-6.

In one embodiment, the cheese composition comprises

milk and

a whey protein granule composition, comprising;

a vegetable protein material and

a liquid dairy whey;

wherein the weight ratio of milk to the whey protein granule composition is from about 5-100 to about 1 and further wherein the weight ratio of the vegetable protein material to the liquid dairy whey in the whey protein granule composition is from about 1 to about 2-6.

In another embodiment, the protein granule composition is a milk protein granule composition that comprises

a vegetable protein material and

a liquid milk;

wherein the weight ratio of the vegetable protein material to the liquid milk is from about 1 to about 2-6.

In another embodiment, the cheese composition comprises

liquid milk and

a milk protein granule composition, comprising;

a vegetable protein material and

a liquid milk;

wherein the weight ratio of liquid milk (A) to the milk protein granule composition (B) is from about 5-100 to about 1 and further wherein the weight ratio of the vegetable protein material (a) to the liquid milk (b) in the milk protein granule composition (B) is from about 1 to about 2-6.

The whey protein granule composition and the milk protein granule composition have a color such that when these granules are used in making cheese, that the final cheese color is acceptable.

### DETAILED DESCRIPTION OF THE INVENTION

### Definitions of Terms

“Whiteness index” is a measure of the appearance of whey protein granule compositions and milk protein granule compositions. In general, the whiteness index is determined using a calorimeter which provides the L, a, and b color values for the composition from which the whiteness index may be calculated using a standard expression of the Whiteness Index (WI), WI=L-3b. The L component generally indicates the whiteness or, “lightness”, of the sample; L values near 0 indicate a black sample while L values near 100 indicate a white sample. The b value indicates yellow and blue colors present in the sample; positive b values indicate the presence of yellow colors while negative b values indicate the presence of blue colors. The a value, which may be used in other color measurements, indicates red and green colors; positive values indicate the presence of red colors while negative values indicate the presence of green colors. For the b and a values, the absolute value of the measurement increases directly as the intensity of the corresponding color increases. Generally, the colorimeter is standardized using a white standard tile provided with the colorimeter. A sample is then placed into a glass cell which is introduced to the calorimeter. The sample cell is covered with an opaque cover to minimize the possibility of ambient light reaching the detector through the sample and serves as a constant during measurement of the sample. After the reading is taken, the sample cell is emptied and typically refilled as multiple samples of the same material are generally measured and the whiteness index of the material expressed as the average of the measurements. Suitable calorimeters generally include those manufactured by HunterLab (Reston, Va.) including, for example, Model # DP-9000 with Optical Sensor D 25. In general, the whey protein granule compositions and the milk protein granule compositions typically have a whiteness index of at least 45.

In the conventional manufacture of cheese, milk is processed to form a coagulum, which is further processed to produce a semi-solid mass called “cheese curd” (or “curd”) and a liquid (whey). The curd contains casein, a small amount of lactose, most of the butterfat, minerals, and water. The whey contains whey proteins, most of the lactose, some of the butterfat, minerals, and water. The curd may be worked (e.g., stirred) and/or combined with certain flavor and taste producing ingredients, and/or ripened using bacteria to produce different varieties of “natural cheese.”

“Conventional cheese” as used herein means a cheese made by the traditional method of coagulating milk, cutting the coagulated milk to form discrete curds, stirring and heating the curd, draining off the whey, and collecting or pressing the curd. Cow's milk contains whey proteins and casein at a weight ratio of about 1:4 whey proteins to casein. The conventional process for making natural cheese recovers the casein from the milk. Whey proteins dissolved in the whey are mostly discharged during the whey drainage step. The whey proteins to casein ratio are between about 1:150 and about 1:40 for conventional cheese. For example, Cheddar cheese contains about 0.3% whey proteins. The whey proteins to casein ratio are about 1:100 in typical Cheddar cheese, the most common conventional cheese.

“American-type cheeses” as used herein means the group of conventional cheeses including Cheddar, washed curd, Colby, stirred curd cheese and Monterey Jack. All must contain at least 50 percent fat in dry matter (FDM). Modifications in the process for making Cheddar led to the development of the other three varieties. Washed curd cheese is prepared as Cheddar through the milling stage, when the curd is covered with cold water for 5 to 30 minutes. Washing increases moisture to a maximum of 42 percent. Stirred curd cheese has practically the same composition as Cheddar but has a more open texture and shorter (less elastic) body. It is manufactured as Cheddar except that agitation of cooked curd particles is used to promote whey drainage, and the Cheddaring and milling steps are eliminated. Colby cheese and Monterey Jack cheese are manufactured the same way as stirred curd except that water is added to wash and cool the curd when most of the whey has been drained away, thus increasing the moisture content to a maximum of 40 percent for Colby cheese and 44 percent for Monterey Jack cheese.

“Pasta filata-type cheese” as used herein means a type of cheese having a plastic, pliable, homogeneous, stringy structure. The pasta filata cheeses are traditionally made by producing curds and whey, draining the whey and immersing the curd in hot water or hot whey and working, stretching, and molding the curd while it is in a plastic condition. The principal varieties of pasta filata cheeses are: Cociocavallo, Provolone, Provolette, Pizza cheese, Mozzarella, Provole, Scamorze, and Provatura. The most well-known example of pasta filata-type cheese is Mozzarella. In the U.S., the Standards of Identity of the Code of Federal Regulations subdivides Mozzarella cheeses into: “Mozzarella”, “Low Moisture Mozzarella,” “Part Skim Mozzarella”, and “Low Moisture Part Skim Mozzarella.” As defined by Food and Drug Administration (FDA) regulations, Mozzarella has a moisture content of more than 52 but not more than 60 weight percent and fat in dry matter (FDM) of not less than 45 percent by weight. The Low Moisture Mozzarella has a moisture content of more than 45 but not more than 52 weight percent and FDM of not less than 45 weight percent. The Part Skim Mozzarella contains more than 52 but not more than 60 percent of moisture by weight and has FDM of less than 45 but not less than 30 percent. The Low Moisture Part Skim Mozzarella contains more than 45 but not more than 52 percent of moisture by weight and has FDM of less than 45 but not less than 30 percent.

“Processed cheese” as used herein generally refers to a class of cheese products that are produced by comminuting, mixing and heating natural cheese into a homogeneous, plastic mass, with emulsifying agents and optional ingredients, depending on the class of processed cheese produced. The comminuted cheese is blended and sent to cookers or the like which commonly heat the mass to a temperature of 165° F.-185° F. During cooking, fat is stabilized with the protein and water by the emulsifying agents, which are typically citrate or phosphate salts, usually at a level of about 30%. The salts cause the protein to become more soluble. Under these circumstances a stable emulsion of protein, fat and water occurs to provide a smooth, homogeneous mass. The hot mass is packaged directly, or formed into slices and packaged There are four main classes of processed cheese: pasteurized process cheese, pasteurized process cheese food, pasteurized process cheese spread and pasteurized process cheese product. All four classes of processed cheese are made with emulsifying agents. In the U.S., Standards of Identity apply to pasteurized process cheese and are established by the FDA. By those standards, whey solids, including whey proteins, may not be added to the pasteurized process cheese.

“Emulsifying agents” as used herein means emulsifying agents used in the making of processed cheese. These include one or any mixture of two or more of the following inorganic salts: monosodium phosphate, disodium phosphate, dipotassium phosphate, trisodium phosphate, sodium metaphosphate, sodium acid pyrophosphate, tetrasodium pyrophosphate, sodium aluminum phosphate, sodium citrate, potassium citrate, calcium citrate, sodium tartrate, and sodium potassium tartrate. In processed cheese, these emulsifying agents act as calcium sequestering (or chelating) agents.

“Natural cheese” as used herein means a cheese that does not contain emulsifying agents. Conventional cheeses (containing very small amounts of whey proteins) and cheeses made using a UF process (containing high levels of whey proteins) are the usual varieties of natural cheeses. The present invention involves a natural cheese with high levels of whey proteins.

The Vegetable Protein Material

The vegetable protein material is selected from the group consisting of protein derived from soybeans, corn, peas, canola seeds, sunflower seeds, rice, amaranth, lupin, rape seeds, and mixtures thereof. A preferred vegetable protein material is soy protein derived from soybeans. The soy protein is selected from the group consisting of a soy protein isolate, a soy protein concentrate, a soy protein flour, and mixtures thereof.

It is further contemplated that whole soybeans used in the process of the present invention may be standard, commoditized soybeans, soybeans that have been genetically modified (GM) in some manner, or non-GM identity preserved soybeans.

Soy protein isolates useful as the vegetable protein material may be produced from soybeans according to conventional processes in the soy protein manufacturing industry. Exemplary of such a process, whole commodity soybeans are initially detrashed, cracked, dehulled, degermed, and defatted according to conventional processes to form soy flakes, soy flour, soy grits, or soy meal. The soybeans may be detrashed by passing the soybeans through a magnetic separator to remove iron, steel, and other magnetically susceptible objects, followed by shaking the soybeans on progressively smaller meshed screens to remove soil residues, pods, stems, weed seeds, undersized beans, and other trash. The detrashed soybeans may be cracked by passing the soybeans through cracking rolls. Cracking rolls are spiral-cut corrugated cylinders which loosen the hull as the soybeans pass through the rolls and crack the soybean material into several pieces. The cracked soybeans may then be dehulled by aspiration. The dehulled soybeans are degermed by shaking the dehulled soybeans on a screen of sufficiently small mesh size to remove the small sized germ and retain the larger cotyledons of the beans. The cotyledons are then flaked by passing the cotyledons through a flaking roll. The flaked cotyledons are defatted by extracting oil from the flakes by contacting the flakes with hexane or other suitable lipophilic/hydrophobic solvent. The edible defatted flakes are then milled, usually in an open-loop grinding system, by a hammer mill, classifier mill, roller mill or impact pin mill first into grits, and with additional grinding, to form a soy meal, or a soy flour, with desired particle sizes. Screening is typically used to size the product to uniform particle size ranges, and can be accomplished with shaker screens or cylindrical centrifugal screeners.

The defatted soy flakes, soy flour, soy grits, or soy meal thus formed is/are then extracted with an aqueous alkaline solution, typically a dilute aqueous sodium hydroxide solution having a pH of from 7.5 to 11.0, to extract protein soluble in an aqueous alkaline solution from insolubles. The insolubles are soy cotyledon fiber which is composed primarily of insoluble carbohydrates. An aqueous alkaline extract containing the soluble protein is subsequently separated from the insolubles, and the extract is then treated with an acid to lower the pH of the extract to around the isoelectric point of the soy protein, preferably to a pH of from 4.0 to 5.0, and most preferably to a pH of from 4.4 to 4.6. The soy protein precipitates from the acidified extract due to the lack of solubility of the protein in an aqueous solution at or near its isoelectric point. The precipitated protein curd is then separated from the remaining extract (whey). The separated protein may be washed with water to remove residual soluble carbohydrates and ash from the protein material. Water is added to the precipitated protein curd and the pH of the curd is adjusted to between about 6.5 and about 7.5. The separated protein is then dried using conventional drying means such as spray drying or tunnel drying to form a soy protein isolate. Soy protein isolates useful as the vegetable protein material are commercially available. For example, soy protein isolates SUPRO® 500E, SUPRO® EX 33, SUPRO® 620, SUPRO® 630, SUPRO® 120, SUPRO® 545, and SUPRO® 548 are available from Solae, LLC (St. Louis, Mo.).

Soy protein concentrate may be blended with the soy protein isolate to substitute for a portion of the soy protein isolate as a source of soy protein. Preferably, if a soy protein concentrate is substituted for a portion of the soy protein isolate, the soy protein concentrate is substituted for up to about 40% of the soy protein isolate by weight, at most, and more preferably is substituted for up to about 30% of the soy protein isolate by weight.

Soy protein concentrates useful as the soy protein material are commercially available. For example, soy protein concentrates Promine® DSPC, Response®, Procon®, Alpha™ 12 and Alpha™ 5800 are available from Solae, LLC (St. Louis, Mo.). Soy protein concentrates useful in the present invention may also be produced from commodity soybeans according to conventional processes in the soy protein manufacturing industry. For example, defatted soy flakes, soy flour, soy grits, or soy meal produced as described above may be washed with aqueous ethanol (preferably about 60% to about 80% aqueous ethanol) to remove soluble carbohydrates from the soy protein and soy fiber. The soy protein and soy fiber containing material is subsequently dried to produce the soy protein concentrate. Alternatively, the defatted soy flakes, soy flour, soy grits, or soy meal may be washed with an aqueous acidic wash having a pH of from about 4.3 to about 4.8 to remove soluble carbohydrates from the soy protein and soy fiber. After removing the soluble carbohydrates, water is added and the pH is adjusted to between about 6.5 and about 7.5. The soy protein and soy fiber containing material is subsequently dried to produce the soy protein concentrate.

The Liquid Dairy Whey

The term “whey proteins” means cow's milk proteins that do not precipitate in conventional cheese making processes. The primary whey proteins are lactalbumins and lactoglobulins. Other whey proteins that are present in significantly smaller concentrations include euglobulin, pseudoglobulin, and immunoglobulins.

As used herein, “whey protein” relates to the proteins contained in the dairy liquid (i.e., whey) obtained as a supernatant of the curds when milk or a dairy liquid containing milk components are curded to produce a cheese-making curd as a semisolid. Whey protein is generally understood to include principally the globular proteins β-lactoglobulin and α-lactalbumin. It may also include significantly lower concentrations of immunoglobulin and other globulins/albumins.

The derivation of liquid dairy whey, and the differences between sweet and acid liquid dairy wheys has already been disclosed herein. It remains only to be noted: firstly that the liquid dairy wheys should not have undergone any significant microbiological or other spoilage; and, secondly, that the use of sweet liquid whey results in a product which is very much superior to those obtainable when acid whey is used.

As a generalization, any or all of the following; an unusually high acidity, (i.e. an unusually low pH) a high ash content, or the presence of large insoluble aggregated particles in a liquid dairy whey are indicative of one or more of:

(1) poor handling and storage of the whey;

(2) microbiological spoilage;

(3) attempts to restore pH through the use of buffers or basic salts so as to mask the effects of (1) or (2) and to thereby give the appearance of restoring the product to its original specifications; or

(4) if pre-pasteurized, excessive heat treatment during that pasteurization.

For the present purposes, none of these attributes are desirable (i.e. the whey proteins should be in a substantially undenatured form) and a preferred liquid dairy whey starting material should have none of these characteristics. Clearly any deficiencies in the original liquid dairy whey will be carried through processing and manifest deleteriously in the final product.

The preferred sweet liquid dairy whey is one which is derived from fresh, undried, liquid dairy whey, and which is not itself dried prior to use according to the present invention.

A whey pasteurization treatment is optional. As a practical matter however, pasteurization will be useful and preferable in most commercial instances in order to avoid disadvantageous microbial spoilage.

The conditions which may be utilized herein to treat the liquid dairy whey are typical of the pasteurization times and temperatures useful in processing other materials, such as milk for example. Thus a batch process, for example, might require a temperature of about 60° C. for 30 minutes. Similarly the widely known continuous and high temperature short residence time pasteurization processes (about 71° C. for 15 seconds) is also applicable for the purposes of the present invention. The high temperature short residence time pasteurization process is preferred however, since the conditions prevailing in such processing have less effect on the flavor of the final product and the process is continuous.

The Liquid Milk

Milk is a mixture of proteins of casein and whey proteins wherein the milk is obtained the milking of females of a mammalian species of animals selected from the group consisting of cow, sheep, goat, water buffalo, camel, and mixtures thereof. Generally, however, cows' milk is the preferred dairy liquid used in the practice of the invention.

Casein is a phosphoprotein that exists in milk in the form of rather large colloidal particles containing the protein and also considerable quantities of calcium and phosphate and a little magnesium and citrate. These particles can be separated from milk by high-speed centrifugation, leaving the whey proteins and dissolved constituents in solution. They are commonly referred to as “calcium phosphocaseinate” or “calcium caseinate-phosphate.” Casein can be removed from milk in a number of ways besides high-speed centrifugation. The fundamental definition of casein is operational—it is defined as that protein precipitated from milk by acidification to pH 4.6 to 4.7. The calcium and phosphate associated with casein in the original particles progressively dissolved as the pH is lowered until, at the isoelectric point of pH 4.6 to 4.7, the casein is free of bound salts. A second important means of removing casein from milk is by rennet coagulation. The enzyme rennin has the ability to slightly change casein so that it coagulates in the presence of divalent cations such as calcium. This process is used in preparation of cheese curd. It involves the coagulation of the calcium caseinatephosphate particles as such because the pH does not drop and colloidal calcium and phosphate are not dissolved. Thus, the product prepared by rennet coagulation has high ash content as compared with acid-precipitated casein. Since they are stabilized by charge, the caseinate particles are extremely sensitive to changes in ionic environment. They readily aggregate with increase in concentration of these ions. Since their equilibrium dispersion in milk is rather precarious, minor changes in salt balance and pH easily upset this equilibrium and tend to destabilize and precipitate the casein particles. Whey proteins are composed of different fractions mainly lactalbumin and lactoglobulin. Milk contains approximately about 2.5% casein and about 0.6% whey proteins.

Milk protein is preferably supplied by a highly enriched preparation of milk protein which contains less than about 30 percent of other milk components. Milk protein used in the current invention may be a milk protein concentrate or a milk protein isolate, for example. Milk protein concentrates, milk protein isolates, and other appropriate sources of milk proteins are well-known in the food sciences and are available commercially. Examples include ALAPRO 4700 and TMP 1220 (New Zealand Milk Products, Santa Rosa, Calif.) and Nutrilac CH7813 (Arla Foods Ingredients, Videbaek, Denmark).

Milk obtained by milking one or more cows is referred to as “cow's milk”. Cow's milk, whose composition has not been adjusted, is referred to herein as “whole milk”. It is comprised of casein, whey proteins, lactose, minerals, butterfat (milkfat), and water.

The composition of “cow's milk” can be adjusted by the removal of a portion of or all of any of the constituents of whole milk, or by adding thereto additional amounts of such constituents. The term “whole milk” is applied the cow's milk that contains at least 3.25% fat. The term “skim milk” is applied to cow's milk from which sufficient milkfat has been removed to reduce its milkfat content to less than 0.5 percent by weight, and typically to less than 0.1%. The term “low fat milk” (or “part-skim milk”) is applied to cow's milk from which sufficient milkfat has been removed to reduce its milkfat content to the range from about 0.5 to about 2.0 percent by weight, with the 1% and 2% varieties widely marketed.

The additional constituents are generally added to cow's milk in the form of cream, concentrated milk, dry whole milk, skim milk, or nonfat dry milk. “Cream” means the liquid, separated from cow's milk, having a high butterfat content, generally from about 18 to 36 percent by weight. “Concentrated milk” is the liquid obtained by partial removal of water from whole milk. Generally, the milkfat (butterfat) content of concentrated milk is not less than 7.5 weight percent and the milk solids content is not less than 25.5 weight percent. “Dry whole milk” is whole milk having a reduced amount of water. It generally contains not more than five percent by weight of moisture on a milk solids not fat basis. “Nonfat dry milk” is the product obtained by the removal of water only from skim milk. Generally, its water content is not more than five weight percent and its milkfat content is not more than 1.5 weight percent.

Thus, the term “cow's milk” includes, among others, whole milk, low fat milk, (part-skim milk), skim milk, reconstituted milk, recombined milk, and whole milk whose content has been adjusted. As such, in this invention, milk is selected from the group consisting of whole milk, skim milk, part-skim milk, reconstituted milk products and recombined milk products.

Other Components

Other components may be utilized in the preparation of the whey protein granule composition and the milk protein granule composition. These are: buffering agents, colorants, sodium chloride, and cheese flavorants. A buffering agent adjusts the pH of a solution. The function of a buffering agent is to drive an acidic or alkaline solution to a certain pH state and prevent a change in this pH. A preferred buffering agent in the present invention is sodium tri-polyphosphate (STPP) and it is used to raise the pH of the liquid dairy whey or liquid milk. The weight ratio of the vegetable protein material to the buffering agent is from about 1 to about 0.05-0.15 and preferably from about 1 to about 0.07-0.09. Color can be adjusted with the addition of a colorant selected from the group consisting of titanium dioxide, triglycerides, other known colorants, and mixtures thereof. When titanium dioxide is the sole colorant, the weight ratio of the vegetable protein material to titanium dioxide is from about 1 to about 0.01-3 and preferably from about 1 to about 0.02-2.5. When a triglyceride is the sole colorant, the weight ratio of the vegetable protein material to the triglyceride is from about 1 to about 0.5-1.5 and preferably from about 1 to about 0.75-1.25. When the colorant is a combination of the triglyceride and titanium dioxide, the weight ratio of the vegetable protein material to the combination of the triglyceride and titanium dioxide is from about 1 to about 1.5-5 and preferably from about 1 to about 2-4. Sodium chloride is utilized to cause insolubility of the whey protein granule composition or the milk protein granule composition when these protein granule compositions are added to milk for the formation of the cheese composition. The weight ratio of the vegetable protein material to sodium chloride is from about 1 to about 0.04-0.15 and preferably from about 1 to about 0.05-0.1. The purpose of the cheese flavorant in the whey protein granule composition or the milk protein granule composition is to improve the flavor of the finished cheese. Cheese flavorants are carboxylic acids that contain from about 2 carbon atoms up to about 12 carbon atoms. The cheese flavorants may be carboxylic acids selected from the group consisting of acetic acid, propionic acid, butyric acid, valeric acid, caproic acid, caprylic acid, capric acid, lauric acid, and mixtures thereof. Further, the cheese flavorants may be proprietary commercial cheese flavorants or cheese enhancers. The cheese flavorant is typically present in the whey protein granule or the milk protein granule at between about 0.05% up to about 0.3% and preferably from about 0.1% up to about 0.2% of the total weight of the cheese granule.

In the preparation of the whey protein granule composition and the milk protein granule composition, the triglyceride provides an oil-in-water stable emulsion. The term “oil-in-water emulsion” refers to emulsions wherein a discontinuous phase is dispersed within a continuous phase. The triglyceride is the discontinuous phase and the liquid from the liquid whey protein or the liquid milk, as water, is the continuous phase. The oil-in-water emulsion prevents color from fading by forming a stable homogeneous protein suspension.

The triglycerides are of the formula 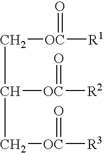
wherein R¹, R², and R³ are independently saturated or unsaturated aliphatic hydrocarbyl groups that contain from about 7 to about 23 carbon atoms. The term “hydrocarbyl group” as used herein denotes a radical having a carbon atom directly attached to the remainder of the molecule. The aliphatic hydrocarbyl groups include the following:

Aliphatic hydrocarbon groups; that is, alkyl groups such as heptyl, nonyl, decyl, undecyl, tridecyl, heptadecyl, octyl; alkenyl groups containing a single double bond such as heptenyl, nonenyl, undecenyl, tridecenyl, heptadecenyl, heneicosenyl; alkenyl groups containing 2 or 3 double bonds such as 8,11-heptadecadienyl and 8,11,14-heptadecatrienyl, and alkynyl groups containing the triple bonds. All isomers of these are included, but straight chain groups are preferred.

Substituted aliphatic hydrocarbon groups; that is groups containing non hydrocarbon substituents which, in the context of this invention, do not alter the predominantly hydrocarbon character of the group. Those skilled in the art will be aware of suitable substituents; examples are hydroxy, carbalkoxy, (especially lower carbalkoxy) and alkoxy (especially lower alkoxy), the term “lower” denoting groups containing not more than 7 carbon atoms.

Hetero groups; that is, groups which, while having predominantly aliphatic hydrocarbon character within the context of this invention, contain atoms other than carbon present in a chain or ring otherwise composed of aliphatic carbon atoms. Suitable hetero atoms will be apparent to those skilled in the art and include, for example, oxygen, nitrogen and sulfur.

Naturally occurring triglycerides are vegetable oil triglycerides and animal fat triglycerides. The preferred vegetable oil triglycerides comprise sunflower oil, safflower oil, corn oil, soybean oil, rapeseed oil, meadowfoam oil, lesquerella oil, or castor oil. The preferred animal fat triglyceride is milkfat. The synthetic triglycerides are those formed by the reaction of one mole of glycerol with three moles of a fatty acid or mixture of fatty acids. The fatty acids contain from about 6 to about 22 carbon atoms. The preferred fatty acids comprise octanoic acid, nonanoic acid, decanoic acid, lauric acid, myristic acid, palmitic acid, stearic acid, eicosanoic acid, triconanoic acid, oleic acid, linoleic acid, linolenic acid or ricinoleic acid.

The triglyceride oils can be synthetic or derived from a plant. For example, triglycerides such as triolein, trieicosenoin, or trierucin can be used as starting materials. Triglycerides are available commercially or can be synthesized using standard techniques. Plant derived oils, i.e., vegetable oils, are particularly useful starting materials, as they allow oils of the invention to be produced in a cost-effective manner. Suitable vegetable oils have a monounsaturated fatty acid content of at least about 50%, based on total fatty acid content, and include, for example, rapeseed (Brassica), sunflower (Helianthus), soybean (Glycine max), corn (Zea mays), crambe (Crambe), and meadowfoam (Limnanthes) oil. Canola oil, which has less than 2% erucic acid, is a useful rapeseed oil. Additional oils such as palm or peanut oil that can be modified to have a high monounsaturated content also are suitable. Oils having a monounsaturated fatty acid content of at least 70% are particularly useful. The monounsaturated fatty acid content can be composed of, for example, oleic acid (C18:1), eicosenoic acid (C20:1), erucic acid (C22:1), or combinations thereof.

Oils having an oleic acid content of about 70% to about 90% are particularly useful. For example, IMC-130 canola oil, available from Cargill, Inc., has an oleic acid content of about 75%, and a polyunsaturated fatty acid content (C18:2 and C18:3) of about 14%. U.S. Pat. No. 5,767,338 describes plants and seeds of IMC 130. See also U.S. Pat. No. 5,861,187. High oleic sunflower oils having oleic acid contents, for example, of about 77% to about 81%, or about 86% to about 92%, can be obtained from A. C. Humko, Memphis, Tenn. U.S. Pat. No. 4,627,192 describes high oleic acid sunflower oils.

Oils having a high eicosenoic acid content include meadowfoam oil. Typically, meadowfoam oil has an eicosenoic acid content of about 60% to about 65%. Such oil is sold by the Fanning Corporation under the trade name “Fancor Meadowfoam”.

Oils having a high erucic acid content include high erucic acid rapeseed (HEAR) oil, and crambe oil. HEAR oil has an erucic acid content of about 45% to about 55%, and is commercially available, for example, from CanAmera Foods (Saskatoon, Canada). For example, a high erucic acid rapeseed line that is sold under the trade name Hero is useful. Other high erucic acid varieties such as Venus, Mercury, Neptune or S89-3673 have erucic acid contents of about 50% or greater and also can be used. McVetty, P. B. E. et al., Can. J. Plant Sci., 76(2):341-342 (1996); Scarth, R. et al., Can. J. Plant Sci., 75(1):205-206 (1995); and McVetty, P. B. E. et al., Can. J. Plant Sci., 76(2):343-344 (1996). Crambe oil has an erucic acid content of about 50% to about 55%, and is available from AgGrow Oils LLC, Carrington, N. Dak.

The whey protein granule composition or the milk protein granule composition is formed by combining the liquid dairy whey or the liquid milk respectively, and the vegetable protein material, wherein the weight ratio of the vegetable protein material to the liquid dairy whey or the liquid milk is from about 1 to about 2-6 and preferably from about 1:3 to about 1:5.

Optional buffering agents, colorants, sodium chloride, and cheese flavorants may also be employed. Typically the liquid dairy whey or the liquid milk and colorants are combined, followed by the vegetable protein material and sodium chloride. The contents are mixed until a homogeneous smooth paste is formed. Alternative one-half of the vegetable protein material may be added with the liquid dairy whey or the liquid milk and the colorant. The contents are mixed and the remainder of the vegetable protein material and salt are added. In either procedure, the contents are heated up to between about 65° C. and about 80° C. While heating is not necessary, the granules form faster if the contents are heated. When the granules are formed, they are reduced in size by running through a cutter or a grinder to a dimension of between about one-eighth to about three-eighths of an inch. It is to be understood that not all of the granules will be of the same particle size. Mixing is carried out by any suitable mixer, e.g. ribbon mixers, v-cone blenders, matrix mixers, Stephan mixers, truncone mixers and cyclomix. Further, the contents may be subjected to high pressure.

Although the invention is not limited to the examples, the following examples serve to illustrate the preparation of the protein granule composition of this invention in more detail. Examples 1-12 are directed to the preparation of whey protein granule compositions. Examples 13-22 are directed to the preparation of milk protein granule compositions. Unless otherwise indicated, parts and % signify parts by weight and % by weight, respectively.

### EXAMPLE 1

Added to a heating vessel is 7745 grams liquid acidic dairy whey having a pH of 4.6 obtained from a typical cheese making process. Then added are 150 grams of powdered sodium tripolyphosphate. The contents are stirred until well dispersed, about three minutes. The pH is adjusted to 6.6. While stirring is continued, a slurry of 49.8 grams titanium dioxide in 49.8 grams water is added over a period of two minutes, followed by the addition of 1936 grams of Supro® EX 33 powder. The contents are mixed for about five minutes or until a homogeneous smooth paste is formed. Added to the paste is 120 grams sodium chloride with the contents being mixed for about one minute. The contents are immediately heated to 70° C. to form granules. Once granules are formed, they are reduced in size using a particle reducer to about that of typical curd of about ⅛ inch by ⅜ inch.

### EXAMPLE 2

Added to a heating vessel is 7862 grams liquid sweet dairy whey having a pH of 6.7 obtained from a typical cheese making process. While stirring, a slurry of 50.5 grams titanium dioxide in 50.5 grams water is added over a period of two minutes, followed by the addition of 1966 grams of Supro® EX 33 powder. The contents are mixed for about five minutes or until a homogeneous smooth paste is formed. Added to the paste is 122 grams sodium chloride with the contents being mixed for about one minute. The contents are immediately heated to 70° C. to form granules. Once granules are formed, they are reduced in size using a particle reducer to about that of typical curd of about ⅛ inch by ⅜ inch.

### EXAMPLE 3

Added to a heating vessel are 400 grams of a 50% solution of titanium dioxide, 342 grams Supro® 120, and 342 grams of Supro® 548. While stirring, 6814 grams of a pH adjusted liquid sweet dairy whey is added and the contents are mixed for about two minutes until a homogeneous smooth paste is formed. Then added are 1500 grams sunflower oil and an additional 342 grams Supro® 120, and 342 grams of Supro® 548. The contents are mixed an additional four minutes followed by the addition of 120 grams of sodium chloride. The contents are mixed for an additional two minutes and then heated up to about 70° C. Once the granules have formed, they are reduced in size by running the granules through a particle reducer to about that of typical curd of about ⅛ inch by ⅜ inch.

### EXAMPLE 4

Added to a heating vessel are 400 grams of a 50% solution of titanium dioxide and 684 grams Supro® 120. While stirring, 6814 grams of a pH adjusted liquid sweet dairy whey is added and the contents are mixed for about two minutes until a homogeneous smooth paste is formed. Then added are 1500 grams sunflower oil and an additional 684 grams Supro® 120. The contents are mixed an additional four minutes followed by the addition of 120 grams of sodium chloride. The contents are mixed for an additional two minutes and then heated up to about 70° C. Once the granules have formed, they are reduced in size by running the granules through a particle reducer to about that of typical curd of about ⅛ inch by ⅜ inch.

### EXAMPLE 5

Added to a heating vessel are 400 grams of a 50% solution of titanium dioxide, 684 grams Supro® 120, and 684 grams of Supro® 548. While stirring, 6814 grams of a pH adjusted liquid sweet dairy whey is added and the contents are mixed for about two minutes until a homogeneous smooth paste is formed. This is followed by the addition of 1500 grams sunflower oil. The contents are mixed an additional four minutes followed by the addition of 120 grams of sodium chloride. The contents are mixed for an additional two minutes and then heated up to about 70° C. Once the granules have formed, they are reduced in size by running the granules through a particle reducer to about that of typical curd of about ⅛ inch by ⅜ inch.

### EXAMPLE 6

Added to a heating vessel are 6814 grams of a pH adjusted liquid sweet dairy whey and 400 grams of a 50% solution of titanium dioxide. While stirring, 1500 grams sunflower oil is added and the contents are subjected to homogenization at 3000 pounds per square inch. After homogenization, 1366 grams of Supro® 545 is added. The contents are mixed an additional four minutes followed by the addition of 120 grams of sodium chloride. The contents are then heated up to about 70° C. Once the granules have formed, they are reduced in size by running the granules through a particle reducer to about that of typical curd of about ⅛ inch by ⅜ inch.

### EXAMPLE 7

Added to a heating vessel are 400 grams of a 50% solution of titanium dioxide, 684 grams Supro® 120, and 684 grams of Supro® 545. While stirring, 6814 grams of a pH adjusted liquid sweet dairy whey is added and the contents are mixed for about two minutes until a homogeneous smooth paste is formed. This is followed by the addition of 1500 grams sunflower oil. The contents are mixed an additional four minutes followed by the addition of 120 grams of sodium chloride. The contents are mixed for an additional two minutes, heated up to about 70° C. and homogenized at 3000 pounds per square inch. Once the granules have formed, they are reduced in size by running the granules through a particle reducer to about that of typical curd of about ⅛ inch by ⅜ inch.

### EXAMPLE 8

Added to a heating vessel are 400 grams of a 50% solution of titanium dioxide and 1366 grams of Supro® 548. While stirring, 6814 grams of a pH adjusted liquid sweet dairy whey is added and the contents are mixed for about two minutes until a homogeneous smooth paste is formed. This is followed by the addition of 1500 grams sunflower oil. The contents are mixed an additional four minutes followed by the addition of 120 grams of sodium chloride. The contents are mixed for an additional two minutes, heated up to about 70° C. and homogenized at 3000 pounds per square inch. Once the granules have formed, they are reduced in size by running the granules through a particle reducer to about that of typical curd of about ⅛ inch by ⅜ inch.

### EXAMPLE 9

Added to a heating vessel are 400 grams of a 50% solution of titanium dioxide and 1366 grams of Supro® 120. While stirring, 6814 grams of a pH adjusted liquid sweet dairy whey is added and the contents are mixed for about two minutes until a homogeneous smooth paste is formed. This is followed by the addition of 1500 grams sunflower oil. The contents are mixed an additional four minutes followed by the addition of 120 grams of sodium chloride. The contents are mixed for an additional two minutes, heated up to about 70° C. and homogenized at 3000 pounds per square inch. Once the granules have formed, they are reduced in size by running the granules through a particle reducer to about that of typical curd of about ⅛ inch by ⅜ inch.

### EXAMPLE 10

Added to a heating vessel are 400 grams of a 50% solution of titanium dioxide, 342 grams Supro® 120, and 342 grams of Supro® 545. While stirring, 6814 grams of a pH adjusted liquid sweet dairy whey is added and the contents are mixed for about two minutes until a homogeneous smooth paste is formed. Then added are 1500 grams sunflower oil and an additional 342 grams Supro® 120, and 342 grams of Supro® 545. The contents are mixed an additional four minutes followed by the addition of 120 grams of sodium chloride. The contents are mixed for an additional two minutes and then heated up to about 70° C. Once the granules have formed, they are reduced in size by running the granules through a particle reducer to about that of typical curd of about ⅛ inch by ⅜ inch.

### EXAMPLE 11

Added to a heating vessel are 400 grams of a 50% solution of titanium dioxide and 684 grams Supro® 545. While stirring, 6814 grams of a pH adjusted liquid sweet dairy whey is added and the contents are mixed for about two minutes until a homogeneous smooth paste is formed. Then added are 1500 grams sunflower oil and an additional 684 grams Supro® 545. The contents are mixed an additional four minutes followed by the addition of 120 grams of sodium chloride. The contents are mixed for an additional two minutes and then heated up to about 70° C. Once the granules have formed, they are reduced in size by running the granules through a particle reducer to about that of typical curd of about ⅛ inch by ⅜ inch.

### EXAMPLE 12

Added to a heating vessel are 400 grams of a 50% solution of titanium dioxide and 684 grams Supro® 545. While stirring, 6814 grams of a pH adjusted liquid sweet dairy whey is added and the contents are mixed for about two minutes until a homogeneous smooth paste is formed. Then added are 1500 grams sunflower oil and an additional 684 grams Supro® 548. The contents are mixed an additional four minutes followed by the addition of 120 grams of sodium chloride. The contents are mixed for an additional two minutes and then heated up to about 70° C. Once the granules have formed, they are reduced in size by running the granules through a particle reducer to about that of typical curd of about ⅛ inch by ⅜ inch.

### EXAMPLE 13

Added to a heating vessel are 400 grams of a 50% solution of titanium dioxide, 342 grams Supro® 120, and 342 grams of Supro® 548. While stirring, 6814 grams of a pH adjusted liquid milk is added and the contents are mixed for about two minutes until a homogeneous smooth paste is formed. Then added are 1500 grams sunflower oil and an additional 342 grams Supro® 120, and 342 grams of Supro® 548. The contents are mixed an additional four minutes followed by the addition of 120 grams of sodium chloride. The contents are mixed for an additional two minutes and then heated up to about 70° C. Once the granules have formed, they are reduced in size by running the granules through a particle reducer to about that of typical curd of about ⅛ inch by ⅜ inch.

### EXAMPLE 14

Added to a heating vessel are 400 grams of a 50% solution of titanium dioxide and 684 grams Supro® 120. While stirring, 6814 grams of a pH adjusted liquid milk is added and the contents are mixed for about two minutes until a homogeneous smooth paste is formed. Then added are 1500 grams sunflower oil and an additional 684 grams Supro® 120. The contents are mixed an additional four minutes followed by the addition of 120 grams of sodium chloride. The contents are mixed for an additional two minutes and then heated up to about 70° C. Once the granules have formed, they are reduced in size by running the granules through a particle reducer to about that of typical curd of about ⅛ inch by ⅜ inch.

### EXAMPLE 15

Added to a heating vessel are 400 grams of a 50% solution of titanium dioxide, 684 grams Supro® 120, and 684 grams of Supro® 548. While stirring, 6814 grams of a pH adjusted liquid milk is added and the contents are mixed for about two minutes until a homogeneous smooth paste is formed. This is followed by the addition of 1500 grams sunflower oil. The contents are mixed an additional four minutes followed by the addition of 120 grams of sodium chloride. The contents are mixed for an additional two minutes and then heated up to about 70° C. Once the granules have formed, they are reduced in size by running the granules through a particle reducer to about that of typical curd of about ⅛ inch by ⅜ inch.

### EXAMPLE 16

Added to a heating vessel are 400 grams of a 50% solution of titanium dioxide and 1366 grams of Supro® 545. While stirring, 6814 grams of a pH adjusted liquid milk is added and the contents are mixed for about two minutes until a homogeneous smooth paste is formed. This is followed by the addition of 1500 grams sunflower oil. The contents are mixed an additional four minutes followed by the addition of 120 grams of sodium chloride. The contents are mixed for an additional two minutes, heated up to about 70° C. and homogenized at 3000 pounds per square inch. Once the granules have formed, they are reduced in size by running the granules through a particle reducer to about that of typical curd of about ⅛ inch by ⅜ inch.

### EXAMPLE 17

Added to a heating vessel are 400 grams of a 50% solution of titanium dioxide, 684 grams Supro® 120, and 684 grams of Supro® 545. While stirring, 6814 grams of a pH adjusted liquid milk is added and the contents are mixed for about two minutes until a homogeneous smooth paste is formed. This is followed by the addition of 1500 grams sunflower oil. The contents are mixed an additional four minutes followed by the addition of 120 grams of sodium chloride. The contents are mixed for an additional two minutes, heated up to about 70° C. and homogenized at 3000 pounds per square inch. Once the granules have formed, they are reduced in size by running the granules through a particle reducer to about that of typical curd of about ⅛ inch by ⅜ inch.

### EXAMPLE 18

Added to a heating vessel are 400 grams of a 50% solution of titanium dioxide and 1366 grams of Supro® 548. While stirring, 6814 grams of a pH adjusted liquid milk is added and the contents are mixed for about two minutes until a homogeneous smooth paste is formed. This is followed by the addition of 1500 grams sunflower oil. The contents are mixed an additional four minutes followed by the addition of 120 grams of sodium chloride. The contents are mixed for an additional two minutes, heated up to about 70° C. and homogenized at 3000 pounds per square inch. Once the granules have formed, they are reduced in size by running the granules through a particle reducer to about that of typical curd of about ⅛ inch by ⅜ inch.

### EXAMPLE 19

Added to a heating vessel are 400 grams of a 50% solution of titanium dioxide and 1366 grams of Supro® 120. While stirring, 6814 grams of a pH adjusted liquid milk is added and the contents are mixed for about two minutes until a homogeneous smooth paste is formed. This is followed by the addition of 1500 grams sunflower oil. The contents are mixed an additional four minutes followed by the addition of 120 grams of sodium chloride. The contents are mixed for an additional two minutes, heated up to about 70° C. and homogenized at 3000 pounds per square inch. Once the granules have formed, they are reduced in size by running the granules through a particle reducer to about that of typical curd of about ⅛ inch by ⅜ inch.

### EXAMPLE 20

Added to a heating vessel are 400 grams of a 50% solution of titanium dioxide, 342 grams Supro® 120, and 342 grams of Supro® 545. While stirring, 6814 grams of a pH adjusted liquid milk is added and the contents are mixed for about two minutes until a homogeneous smooth paste is formed. Then added are 1500 grams sunflower oil and an additional 342 grams Supro® 120, and 342 grams of Supro® 545. The contents are mixed an additional four minutes followed by the addition of 120 grams of sodium chloride. The contents are mixed for an additional two minutes and then heated up to about 70° C. Once the granules have formed, they are reduced in size by running the granules through a particle reducer to about that of typical curd of about ⅛ inch by ⅜ inch.

### EXAMPLE 21

Added to a heating vessel are 400 grams of a 50% solution of titanium dioxide and 684 grams Supro® 545. While stirring, 6814 grams of a pH adjusted liquid milk is added and the contents are mixed for about two minutes until a homogeneous smooth paste is formed. Then added are 1500 grams sunflower oil and an additional 684 grams Supro® 545. The contents are mixed an additional four minutes followed by the addition of 120 grams of sodium chloride. The contents are mixed for an additional two minutes and then heated up to about 70° C. Once the granules have formed, they are reduced in size by running the granules through a particle reducer to about that of typical curd of about ⅛ inch by ⅜ inch.

### EXAMPLE 22

Added to a heating vessel are 400 grams of a 50% solution of titanium dioxide and 684 grams Supro® 545. While stirring, 6814 grams of a pH adjusted liquid milk is added and the contents are mixed for about two minutes until a homogeneous smooth paste is formed. Then added are 1500 grams sunflower oil and an additional 684 grams Supro® 548. The contents are mixed an additional four minutes followed by the addition of 120 grams of sodium chloride. The contents are mixed for an additional two minutes and then heated up to about 70° C. Once the granules have formed, they are reduced in size by running the granules through a particle reducer to about that of typical curd of about ⅛ inch by ⅜ inch.

The color data of the whey protein granule compositions and the milk protein granule compositions are shown in Table 2. The color of the whey protein granule compositions and the milk protein granule compositions has minimal effect on the final color of the cheese. That is, the color of the whey protein granule compositions and the milk protein granule compositions can be adjusted during granule formation to a target color of the cheese.

TABLE 2
Color Data

| Example No. | Whiteness Index | L value | a value | b value |
|---|---|---|---|---|
| 6 | 46.11 | 82.8 | 1.06 | 12.23 |
| 8 | 54.89 | 86.12 | −0.09 | 10.41 |
| 9 | 50.52 | 84.51 | 0.47 | 11.33 |

Cheese Preparation

Once granules are added to the milk, the standard cheese process is followed incorporating the granules into the cheese composition in that curds and whey are formed. The weight ratio of milk to the protein granule composition is from about 25-100 to about 1, and preferably from about 30-50 to about 1. The casein (curds) is formed by addition of a coagulant. The reaction to prepare the curds and the whey is conducted by employing a coagulant selected from the group consisting of cultures, rennet enzyme, a food grade acid, fermentation, and mixtures thereof. Typical food grade acids are selected from the group consisting of hydrochloric acid, acetic acid, citric acid, phosphoric acid, lactic acid and mixtures thereof. Milk, calcium chloride, and either the whey protein granules or the milk protein granules are added to a vessel and while stirring, a coagulant or coagulants are added. The contents are stirred to effect distribution of the coagulant(s) and the stirring is then stopped to permit curd formation. The curd is cut, allowed to set for a few minutes and then cooked up to about 40° C. via addition of water or steam. The contents are then agitated gently to separate the whey. Granules may or may not float depending on density. Alternatively, the vessel may only contain milk and calcium chloride. Coagulation is effected and at this point, either the whey protein granules or the milk protein granules are added. Once whey is drained, curds are salted, mixed thoroughly and placed into molds. Molds are placed under mechanical pressure of between about 30 pounds per square inch and about 50 pounds per square inch for about 45 minutes.

Although the invention is not limited to the examples, the following examples serve to illustrate the preparation of the cheese compositions of this invention in more detail. Examples 23 and 24 are baseline examples of cheese preparation wherein protein granules are not used. Example 23 is directed to a baseline cheese made using an acid that correspondingly generates an acidic liquid dairy whey. Example 24 is directed to a baseline cheese made not using an acid, but rather a rennet that correspondingly generates a sweet liquid dairy whey.

Examples 26 and 27 are the inventive examples wherein protein granules are used. Example 26 is directed to a cheese made using whey protein granules prepared from a sweet liquid dairy whey of Example 2. Example 27 is directed to a cheese made using whey protein granules prepared from a sweet liquid dairy whey of Example 6. Example 28 is directed to a cheese made using milk granules prepared from a liquid milk of Example 3. Unless otherwise indicated, parts and % signify parts by weight and % by weight, respectively.

### EXAMPLE 23

Added to a cheese vat are 9971 grams of whole milk having a temperature of 33° C. The contents are heated to 35° C. and 21.7 grams of 88% lactic acid is added. The lactic acid addition causes the pH to decrease from 6.8 to 5.2. Then added are 0.3 grams of solid calcium chloride. Mixing is continued for five minutes, at which time 7.1 grams rennet is added. After further mixing for five minutes, the contents are permitted to rest for 40 minutes while coagulation occurs. The curd formed from this coagulation is cut by repeatedly running a wire cutter through the curd from one end of the vessel to the other. The curd is separated from the whey while the temperature is slowly increased to 40° C. The whey is then drained from the vat, leaving the curd behind. The curd is pressed to remove as much whey as possible. The curd is transferred to preformed molds and a pressure is applied at 50 pounds per square inch for two hours to give a baseline cheese made from acid liquid dairy whey.

### EXAMPLE 24

Added to a cheese vat are 9993 grams of whole milk having a temperature of 33° C. Then added are 0.3 grams of solid calcium chloride. Mixing is continued for five minutes, at which time 7.1 grams rennet is added. After further mixing for five minutes, the contents are permitted to rest for 40 minutes while coagulation occurs. The curd formed from this coagulation is cut by repeatedly running a wire cutter through the curd from one end of the vessel to the other. The curd is separated from the whey while the temperature is slowly increased to 40° C. The whey is then drained from the vat, leaving the curd behind. The curd is pressed to remove as much whey as possible. The curd is transferred to preformed molds and a pressure is applied at 50 pounds per square inch for two hours to give a baseline cheese made from sweet liquid dairy whey.

### EXAMPLE 25

Added to a cheese vat are 9771 grams of whole milk having a temperature of 33° C. While stirring, 200 grams of the whey protein granules from Example 1 are added to the milk. The contents are heated to 35° C. and 21.7 grams of 88% lactic acid is added. The lactic acid addition causes the pH to decrease from 6.8 to 5.2. Then added are 0.3 grams of solid calcium chloride. Mixing is continued for five minutes, at which time 7.1 grams rennet is added. After further mixing for five minutes, the contents are permitted to rest for 40 minutes while coagulation occurs. The curd formed from this coagulation is cut by repeatedly running a wire cutter through the curd from one end of the vessel to the other. The curd is separated from the whey while the temperature is slowly increased to 40° C. The whey is then drained from the vat, leaving the curd behind. The curd is pressed to remove as much whey as possible. The curd is transferred to preformed molds and a pressure is applied at 50 pounds per square inch for two hours to give a cheese made from acid liquid dairy whey.

### EXAMPLE 26

Added to a cheese vat are 9713 grams of whole milk having a temperature of 33° C. While stirring, 280 grams of the whey protein granules from Example 2 are added to the milk. The contents are heated to 35° C. and added are 0.3 grams of solid calcium chloride. Mixing is continued for five minutes, at which time 7.1 grams rennet is added. After further mixing for five minutes, the contents are permitted to rest for 40 minutes while coagulation occurs. The curd formed from this coagulation is cut by repeatedly running a wire cutter through the curd from one end of the vessel to the other. The curd is separated from the whey while the temperature is slowly increased to 40° C. The whey is then drained from the vat, leaving the curd behind. The curd is pressed to remove as much whey as possible. The curd is transferred to preformed molds and a pressure is applied at 50 pounds per square inch for two hours to give a cheese made from sweet liquid dairy whey.

### EXAMPLE 27

Added to a cheese vat are 9713 grams of whole milk having a temperature of 33° C. While stirring, 280 grams of the whey protein granules from Example 6 are added to the milk. The contents are heated to 35° C. and added are 0.3 grams of solid calcium chloride. Mixing is continued for five minutes, at which time 7.1 grams rennet is added. After further mixing for five minutes, the contents are permitted to rest for 40 minutes while coagulation occurs. The curd formed from this coagulation is cut by repeatedly running a wire cutter through the curd from one end of the vessel to the other. The curd is separated from the whey while the temperature is slowly increased to 40° C. The whey is then drained from the vat, leaving the curd behind. The curd is pressed to remove as much whey as possible. The curd is transferred to preformed molds and a pressure is applied at 50 pounds per square inch for two hours to give a cheese made from sweet liquid dairy whey.

### EXAMPLE 28

Added to a cheese vat are 9713 grams of whole milk having a temperature of 33° C. While stirring, 0.3 grams of calcium chloride and 280 grams of the milk protein granules from Example 3 are added to the milk. The contents are heated to 35° C. and 21.7 grams of 88% lactic acid is added. The lactic acid addition causes the pH to decrease from 6.8 to 5.2. After further mixing for five minutes, the contents are permitted to rest for 40 minutes while coagulation occurs. The curd formed from this coagulation is cut by repeatedly running a wire cutter through the curd from one end of the vessel to the other. The curd is separated from the whey while the temperature is slowly increased to 40° C. The whey is then drained from the vat, leaving the curd behind. The curd is pressed to remove as much whey as possible. The curd is transferred to preformed molds and a pressure is applied at 50 pounds per square inch for two hours to give a cheese made from acid liquid dairy whey.

Table 3 compares color data for cheeses from a control and from whey protein granules.

TABLE 3
Cheese Data

| Cheese | | | | | |
|---|---|---|---|---|---|
| Example | Whey Granule | Whiteness | | | |
| No. | Source Example | Index | L | a | b |
| 24 (Control) | — | 60.21 | 89.96 | −0.70 | 9.92 |
| 26 | 2 | 54.65 | 86.62 | 0.29 | 10.65 |
| 27 | 6 | 59.22 | 89.63 | −0.34 | 10.14 |

When introducing elements of the present disclosure or the preferred embodiment(s) thereof, the articles “a”, “an”, “the” and “said” are intended to mean that there are one or more of the elements. The terms “comprising”, “including”, and “having” are intended to be inclusive and mean that there may be additional elements other than the listed elements.

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A whey protein granule composition, comprising;
a vegetable protein material and
a liquid dairy whey;
wherein the weight ratio of the vegetable protein material to the liquid dairy whey is from about 1 to about 2-6.

2. The whey protein granule composition of claim 1 wherein the vegetable protein material is selected from the group consisting of protein derived from legumes, soybeans, corn, peas, canola seeds, sunflower seeds, rice, amaranth, lupin, rape seeds, and mixtures thereof.

3. The whey protein granule composition of claim 1 wherein the vegetable protein material is a soybean protein selected from the group consisting of a soy protein isolate, a soy protein concentrate, a soy protein flour, and mixtures thereof.

4. The whey protein granule composition of claim 5 wherein the soybean protein is a soy protein isolate.

5. The whey protein granule composition of claim 1 further comprising at least one triglyceride selected from the group consisting of a vegetable oil and milk fat.

6. The whey protein granule composition of claim 1 further comprising a carboxylic acid cheese flavorant containing from about 2 carbon atoms up to about 12 carbon atoms.

7. A milk protein granule composition, comprising;
a vegetable protein material and
a liquid milk;
wherein the weight ratio of the vegetable protein material to the liquid milk is from about 1 to about 2-6.

8. The milk protein granule composition of claim 7 wherein the vegetable protein material is selected from the group consisting of protein derived from legumes, soybeans, corn, peas, canola seeds, sunflower seeds, rice, amaranth, lupin, rape seeds, and mixtures thereof.

9. The milk protein granule composition of claim 7 wherein the vegetable protein material is a soybean protein selected from the group consisting of a soy protein isolate, a soy protein concentrate, a soy protein flour, and mixtures thereof.

10. The milk protein granule composition of claim 9 wherein the soybean protein is a soy protein isolate.

11. The milk protein granule composition of claim 7 further comprising at least one triglyceride selected from the group consisting of a vegetable oil and milk fat.

12. The milk protein granule composition of claim 7 further comprising a carboxylic acid cheese flavorant containing from about 2 carbon atoms up to about 12 carbon atoms.

13. A cheese composition, comprising;
milk and
a whey protein granule composition, comprising;
a vegetable protein material and
a liquid dairy whey;
wherein the weight ratio of milk to the whey protein granule composition is from about 5-100 to about 1 and further wherein the weight ratio of the vegetable protein material to the liquid dairy whey in the whey protein granule composition is from about 1 to about 2-6.

14. The cheese composition of claim 13 wherein the vegetable protein material is selected from the group consisting of protein derived from legumes, soybeans, corn, peas, canola seeds, sunflower seeds, rice, amaranth, lupin, rape seeds, and mixtures thereof.

15. The cheese composition of claim 13 wherein the vegetable protein material is a soybean protein selected from the group consisting of a soy protein isolate, a soy protein concentrate, a soy protein flour, and mixtures thereof.

16. The cheese composition of claim 15 wherein the soybean protein is a soy protein isolate.

17. The whey protein granule composition of claim 13 further comprising at least one triglyceride selected from the group consisting of a vegetable oil and milk fat.

18. The whey protein granule composition of claim 13 further comprising a carboxylic acid cheese flavorant containing from about 2 carbon atoms up to about 12 carbon atoms.

19. A cheese composition, comprising;
(A) liquid milk and
(B) a milk protein granule composition, comprising;
(a) a vegetable protein material and
(b) a liquid milk;
wherein the weight ratio of liquid milk (A) to the milk protein granule composition (B) is from about 5-100 to about 1 and further wherein the weight ratio of the vegetable protein material (a) to the liquid milk (b) in the milk protein granule composition (B) is from about 1 to about 2-6.

20. The cheese composition of claim 19 wherein the vegetable protein material is selected from the group consisting of protein derived from legumes, soybeans, corn, peas, canola seeds, sunflower seeds, rice, amaranth, lupin, rape seeds, and mixtures thereof.

21. The cheese composition of claim 19 wherein the vegetable protein material is a soybean protein selected from the group consisting of a soy protein isolate, a soy protein concentrate, a soy protein flour, and mixtures thereof.

22. The cheese composition of claim 21 wherein the soybean protein is a soy protein isolate.

23. The whey protein granule composition of claim 19 further comprising at least one triglyceride selected from the group consisting of a vegetable oil and milk fat.

24. The whey protein granule composition of claim 19 further comprising a carboxylic acid cheese flavorant containing from about 2 carbon atoms up to about 12 carbon atoms.

25. The cheese composition of claim 19 wherein the liquid milk (A) and the liquid milk (a) are independently selected from the group consisting of whole milk, skim milk, part-skim milk, reconstituted milk products and recombined milk products.
